(19) United States
(12) Patent Application Publication
(10) Pub. No.: US 2026/0078957 A1
(43) Pub. Date: Mar. 19, 2026

(54) PRESSURE RING ASSEMBLY WITH WEDGE CONNECTOR

(71) Applicant: METIX (PROPRIETARY) LIMITED, Gauteng (ZA)

(72) Inventors: Jacques VENTER, Kwa-Zulu Natal (ZA); Gabriel Jacobus LOTTER, Pretoria (ZA)

(21) Appl. No.: 19/332,487

(22) Filed: Sep. 18, 2025

(30) Foreign Application Priority Data
Sep. 19, 2024 (NL) 2038665

(51) Int. Cl. F27D 1/14; F27B 3/08; F27D 11/10

(52) U.S. Cl. CPC F27D 1/141; F27D 11/10; F27B 3/08

(57) ABSTRACT

A pressure ring assembly (10) comprises at least first and second segments 12.1, 12.2 which are connected to one another in abutting relationship by a removable wedge connector 14 comprising first and second prongs 36, 38. Each segment comprises a body 20 extending arcuately between first and second side walls 22, 24 thereof. Each segment defines first and second elongate bores 26, 28. Each bore has a radiused wall section 30 facing the adjacent side wall, the radius being at least 15 mm. The first and second prongs diverge away from one another at an angle of less than 15 degrees. The first prong extends into the second bore of the first segment and the second prong extends into the first bore of the second segment. Mutually facing contact faces 46, 48 of the first and second prongs have profiles complementary to the radiused wall sections 30 of the bores.

### INTRODUCTION AND BACKGROUND

This invention relates to electrical metallurgical furnaces and more particularly to a pressure ring segment, a wedge connector and pressure ring assembly for an electrode of such a furnace.

In an electrical furnace, it is common practice to have a pressure ring assembly that serves three main purposes. Firstly, it forms a ring circumscribing electrical contact pads or shoes against which typically a hydraulic force is applied that forces the shoes hard up against the electrode, to ensure good electrical contact. The reaction force is then taken up by the pressure ring assembly. Secondly, the pressure ring needs to protect hydraulic cylinders for activating the contact shoes and piping for cooling fluids from the harsh furnace environment. Thirdly, in some furnaces, the pressure ring assembly act as a cylindrical sleeve and anchor point for heat shields around the electrode and on which a sealing assembly acts to isolate the furnace environment from the atmosphere around the furnace.

These three main purposes therefore require that the pressure ring be a solid round sleeve assembly of significant strength to withstand the hydraulic forces, and be exceptionally heat resistant so as to withstand extremely high temperatures during operation.

It is for this reason that high thermal conductivity materials, like copper, are particularly favourable as they can readily be cooled by means of forced water flow. Lower conductivity materials like aluminium bronze or stainless steel can also be used, but with lesser success as the thermal stresses in an electric smelter, for example, typically cause them to fail much sooner than copper of copper/silver alloys.

Copper, however, suffers from relatively low strength and also creeps over time, if the stresses are not managed carefully.

A further requirement of a pressure ring is the need to have it serviced in as short a period as possible. Components fail for various reasons and in such an event, maintenance personnel need to be able to open the pressure rings up with as little as possible effort, do repairs on the failed components, like the contact shoes or piping, and close the pressure ring back up as fast as possible to resume production.

To this end, the use of a taper wedge or inverse wedge as disclosed in the applicant's WO/2005071335 A2 is highly advantageous as the only tools needed are a crowbar to release the wedge and large hammer to hammer it back into position.

However, in some applications where there are periodic intervals of extreme heat from plasma jets, having a heavier pressure ring than that of WO2005/071335 could be advantageous in that the shear mass of copper can soak up vast amounts of heat energy and effectively transfer the heat to internal water passages for the heat to be removed, thereby keeping the copper relatively cool and unaffected by the extreme heat. To add this additional bulk, the clamping mechanism of WO2005/071335, which comprises an outer peripherally mounted inter-segment wedge connector, may not be ideal, as it requires that a large portion of pressure ring segment body material be removed for the connector's fitment, location and function.

### OBJECT OF THE INVENTION

Accordingly, it is an object of the present invention to provide a pressure ring assembly, a pressure ring segment and a wedge connector for adjacent pressure ring segments with which the applicant believes the aforementioned disadvantages may at least be alleviated or which may provide a useful alternative for the known pressure ring assemblies, pressure ring segments and wedge connectors.

### SUMMARY OF THE INVENTION

According to the invention there is provided a pressure ring assembly having a centre Cr and comprising at least first and second pressure ring segments which are connected to one another in mutually abutting relationship by a removable wedge connector, wherein
each segment
   comprises a body extending arcuately between opposed first and second sidewalls thereof, the first and second sidewalls extending between a top wall and a bottom wall,
   defines first and second elongate bores adjacent the first and second sidewalls, respectively, each bore slanting away from the adjacent sidewall in a direction towards the bottom wall and having a radiused wall section facing the adjacent sidewall, the wall section having a radius (R) of curvature and a centre of curvature Cc on a line (T) tangential to an imaginary circle (I) centred at Cr, the wall section being symmetrical about the line (T);
   defines a first elongate slit in the first sidewall extending from the top wall towards the bottom wall and communicating with the first bore, and a second elongate slit in the second sidewall extending from the top wall towards the bottom wall and communicating with the second bore;
the wedge connector comprises
   first and second prongs diverging away from one another at an angle α towards free ends thereof;
   at least one web formation extending between the first and second prongs; and
   mutually facing contact faces on the prongs configured to engage the radiused wall section of the bores;
      the assembly being configured such that the first prong extends into the second bore of the first segment; the second prong extends into the first bore of the second segment; the at least one web formation extends through the second slit of the first segment and the first slit of the second segment; and the mutually facing contact faces of the first and second prongs abut against the radiused wall sections, thereby mechanically securing the first and second pressure ring segments in side by side configuration, with the first sidewall of the second segment in abutting contact with the second sidewall of the first segment.

The mutually facing contact faces on the prongs may be shaped complementary to the radiused wall section of the bores.

The radius of curvature R may be larger than 15 mm, alternatively larger than 40 mm, further alternatively larger than 70 mm.

The body of each segment may comprise an inner face and an outer face which are separated by a thickness dimension d,

In some embodiments, the radius of curvature R may be larger than 30% of the thickness dimension. In other embodiments, the radius of curvature R may be larger than 50% of the thickness dimension.

The angle α may be less than 15 degrees. Typically, the angle α is between 9 degrees and 13 degrees. In a preferred embodiment the angle α is 12 degrees.

Also included within the scope of the invention is a pressure ring segment comprising a body extending arcuately between opposed first and second sidewalls thereof, the first and second sidewalls extending between a top wall and a bottom wall, the pressure ring segment defining first and second elongate bores adjacent the first and second sidewalls, respectively, each bore slanting away from the adjacent sidewall in a direction towards the bottom wall and having a radiused wall section facing the adjacent sidewall, the wall section having a radius of curvature (R) and a centre of curvature Cc, the wall section defining a first elongate slit in the first sidewall extending from the top wall towards the bottom wall and communicating with the first bore, and a second elongate slit in the second sidewall extending from the top wall towards the bottom wall and communicating with the second bore.

In a presently preferred embodiment, the centre of curvature Cc of the radiused wall section may be located on the side of the radiused wall section opposite said adjacent sidewall. In other embodiments the centre of curvature Cc may be located on the same side of the wall section as said adjacent sidewall.

The body may be made of at least one of copper, a copper alloy comprising at least 98% copper, a copper and silver alloy, aluminium bronze and stainless steel.

Still further included within the scope of the invention is an inter-pressure ring segment wedge connector comprising a head; first and second prongs extending away from the head in diverging relationship relative to one another at an angle α towards free ends thereof; at least one web formation extending between the first and second prongs; and mutually facing curved contact faces on the prongs, the contact faces being radiused having a radius of curvature and a centre of curvature. The centre of curvature of the curved contact face of the first prong may be on the side of said curved face opposite the second prong.

The radius of curvature R may be larger than 15 mm, alternatively larger than 40 mm further alternatively larger than 70 mm.

The at least one web formation may extend laterally centrally between the first and second prongs, so that each prong provides first and second elongate contact face parts symmetrical relative to the at least one web formation.

The head, the first and second prongs and the at least one web formation may be integrally formed.

The wedge connector may be formed from a non-magnetic material.

### BRIEF DESCRIPTION OF THE ACCOMPANYING DIAGRAMS

The invention will now further be described, by way of example only, with reference to the accompanying diagrams wherein:

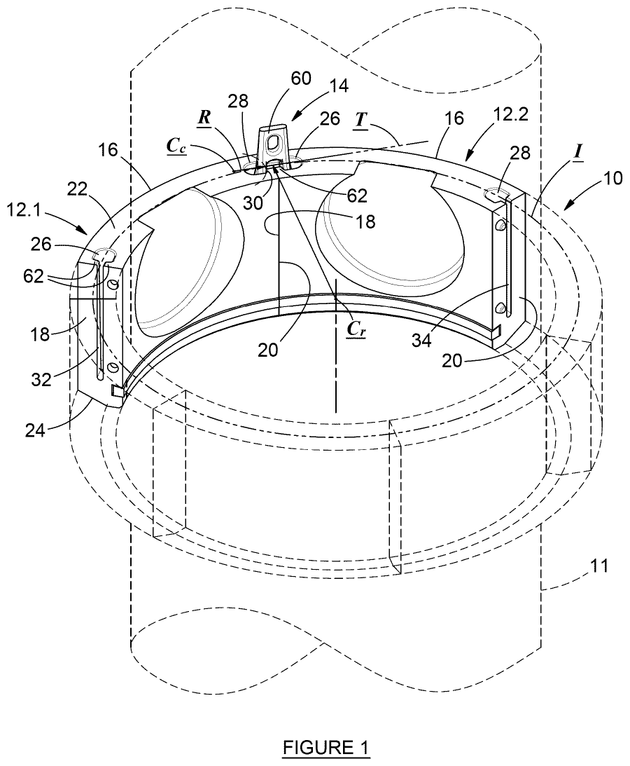

FIG. 1 is a diagrammatic perspective view of relevant parts of first and second pressure ring segments (shown in solid lines) of a pressure ring assembly (shown partially in solid lines and partially in broken lines) circumscribing an electrode (also shown in broken lines) of an electric metallurgical furnace;

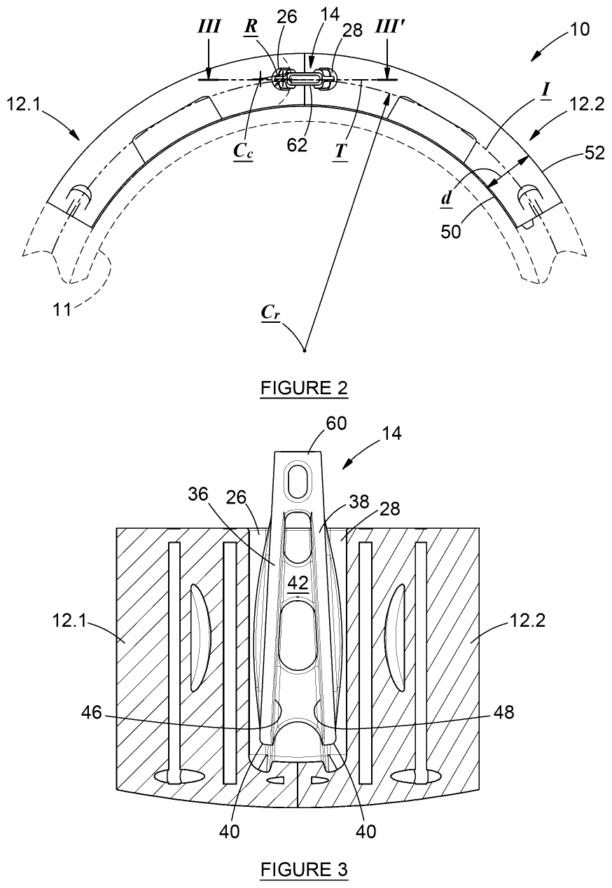

FIG. 2 is a plan view of the first and second pressure ring segments;

FIG. 3 is a section on line III-III′ in FIG. 2; electric metallurgical furnace;

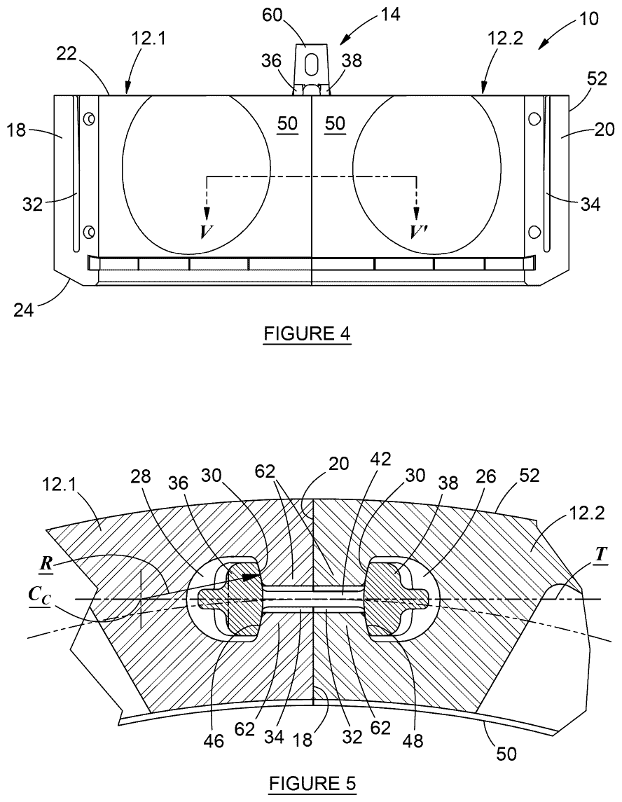

FIG. 4 is a front view of the first and second pressure ring segments; electric metallurgical furnace;

FIG. 5 is a section on line V-V′ in FIG. 4; electric metallurgical furnace;

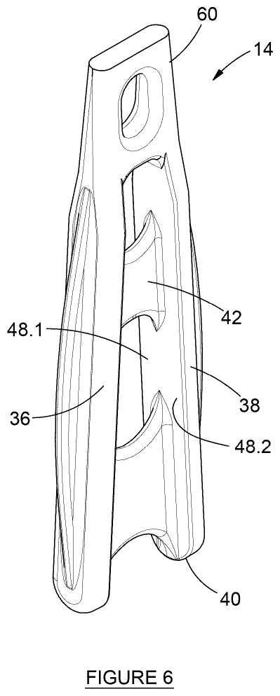

FIG. 6 is a perspective view of a wedge connector for connecting the first and second segments in abutting relationship with one another;

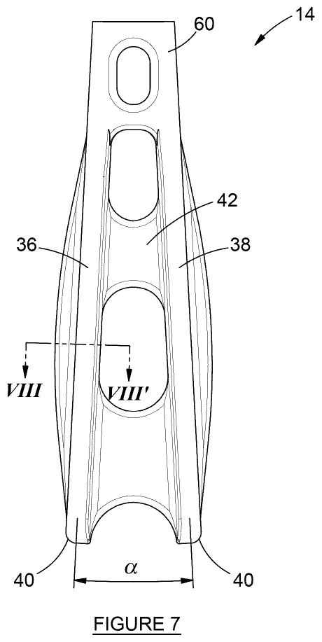

FIG. 7 is a front view of the wedge connector; and electric metallurgical furnace;

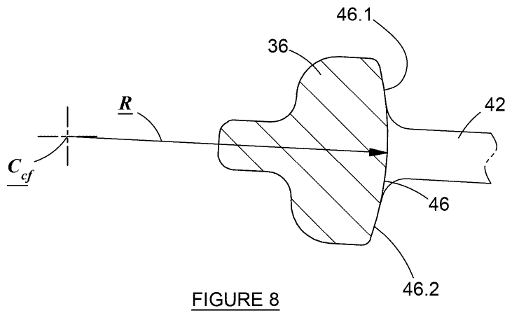

FIG. 8 is a section on line VIII-VIII′ in FIG. 7.

### DESCRIPTION OF A PREFERRED EMBODIMENT OF THE INVENTION

An example embodiment of a pressure ring assembly for an electrode 11 of an electrical metallurgical furnace (not shown) is generally designated by the reference numeral 10 in FIGS. 1, 2 and 4.

Referring to FIG. 1, the pressure ring assembly 10 has a centre Cr and comprises at least first and second pressure ring segments 12.1, 12.2 which are connected to one another in mutually abutting relationship by a removable wedge connector 14. Each segment comprises a body 16 extending arcuately between opposed first and second sidewalls 18, 20 thereof. The sidewalls extend between a top wall 22 and a bottom wall 24. Each segment defines first and second elongate bores 26, 28 adjacent the first and second sidewalls 18, 20, respectively. Each bore slants away from the adjacent sidewall in a direction towards the bottom wall. As best shown in FIG. 5, each bore has a radiused wall section 30 facing the adjacent sidewall. As shown in FIG. 1, the wall section 30 has a radius (R) of curvature and a centre of curvature Cc on a line (T) tangential to an imaginary circle (I) centred at Cr. The wall section 30 is symmetrical about the line (T).

Each segment 12.1, 12.2 also defines a first slit 32 in the first sidewall 18 extending from the top wall towards the bottom wall and communicating with the first bore 26, and a second slit 34 in the second sidewall extending from the top wall towards the bottom wall and communicating with the second bore 28.

The wedge connector 14 comprises first and second prongs 36, 38 diverging away from one another at an angle α towards free ends 40 thereof. At least one web 42 extends between the first and second prongs. The wedge further comprises mutually facing faces 46, 48 on the prongs which are shaped complementary to the radiused wall section 30 of the bores 26, 28.

The pressure ring assembly 10 is configured such that the first prong 36 extends into the second bore 28 of the first segment 12.1; the second prong 38 extends into the first bore 26 of the second segment 12.2; the at least one web formation 42 extends through the second slit 34 of the first segment and the first slit 32 of the second segment; and the mutually facing contact faces 46, 48 of the first and second prongs abut against the radiused wall sections 30, thereby mechanically securing the first and second pressure ring segments 12.1, 12.2 in side by side configuration, with the first sidewall 18 of the second segment 12.2 in abutting contact with the second sidewall 20 of the first segment 12.1.

The pressure ring segments are similar in shape and configuration and therefore reference will be made below to pressure ring segments 12.1 and 12.2, only. The top and bottom walls 22, 24 preferably extend parallel to one another. The first and second sidewalls 18, 20 extend between the top wall 22 and the bottom wall 24. The body of each pressure ring segment further comprises an inner curved face 50 and an outer face 52 (best shown in FIGS. 2, 4 and 5). Preferably the outer face 52 is also curved and extends coaxially with the inner face 50.

The first and second bores 26,28 each slant at an angle of α/2 away from its respective immediately adjacent sidewall 18,20 in a direction from the top wall 22 towards the bottom wall 24.

The angle α may be less than 15 degrees. Typically, the angle α is between 9 degrees and 13 degrees. In a preferred embodiment the angle α is 12 degrees.

The body may be made of at least one of copper, a copper alloy comprising at least 98% copper, a copper and silver alloy, aluminium bronze and stainless steel.

The radius R of curvature of the curved wall section 30 is at least 15 mm, alternatively larger than 40 mm and even larger than 70 mm. As shown in FIG. 1, the centre of curvature Cc of curved wall section 30 of bore 28 is preferably located on the side of the curved wall section 30 opposite the immediately adjacent sidewall 20.

The removable wedge connector 14 is shown in more detail in FIGS. 6 to 8. The connector comprises a head 60 and the first and second elongate prongs 36 and 38 diverging away from one another at angle α in a direction from the head 60 towards the free ends 40. Mutually facing contact faces 46, 48 of the first and second prongs have radiused profiles complementary to the radiused wall sections 30 of the bores 26, 28. The at least one web formation 42 extends between the first and second prongs intermediate the head 60 and free ends 40. The at least one web formation 42 extends laterally and centrally between the first and second prongs 36, 38, so that, as shown in FIG. 8, prong 36 provides first and second elongate contact face parts 46.1, 46.2 symmetrical relative to the at least one web formation and prong 38 provides similar first and second curved elongate contact face parts (not clearly shown) symmetrical relative to the at least one web formation. As shown in FIG. 8 the curved contact faces 46, 48 have a radius of curvature R and a centre of curvature Ccf which is on the side of the face 46,48 opposite the other prong 38, 36. In an example embodiment, the head 60, prongs 36, 38 and the web formations 42 are integrally formed from a non-magnetic steel material.

The present invention retains the benefit of fast and simple assembly and disassembly characteristic of the known pressure ring assemblies, thereby enabling efficient maintenance and reduced furnace downtime. In addition, the design optimizes structural performance by distributing the clamping force evenly across the abutting pressure ring segments. This is achieved through the interaction between the radiused wall sections (30) of the bores (26, 28) and the complementary curved contact faces (46, 48) of the wedge prongs, which accommodates slight misalignment while limiting the development of undesirable bending moments.

The contact faces (46, 48) of the wedge prongs are formed with a relatively large radius of curvature—preferably at least 15 mm, more preferably greater than 30 mm, and in some embodiments exceeding 70 mm. A smaller radius could result in highly concentrated contact forces and unfavourable load angles. For example, if the prong (36), typically having a diameter of less than 30 mm, engages a bore with a small-radius wall section, it may exert excessive outward pressure on the intervening copper lugs (62) (see FIGS. 1 and 5), potentially causing deformation or mechanical failure.

By contrast, the present invention enhances durability by enlarging the contact area between the wedge prongs and the bore wall sections, thereby reducing stress concentrations. Furthermore, due to the internal engagement of the wedge connector within inclined bores—rather than via externally mounted peripheral features as in WO2005/071335—the amount of material that must be machined away from the pressure ring segments is significantly reduced. This preserves thermal mass and structural integrity, particularly when using high-conductivity materials such as copper or copper alloys.

1. A pressure ring assembly having a centre Cr and comprising at least first and
second pressure ring segments which are connected to one another in mutually abutting relationship by a removable wedge connector, wherein
each segment
comprises a body extending arcuately between opposed first and second sidewalls thereof, the first and second sidewalls extending between a top wall and a bottom wall;
defines first and second elongate bores adjacent the first and second sidewalls, respectively, each bore slanting away from the adjacent sidewall in a direction towards the bottom wall and having a radiused wall section facing the adjacent sidewall, the wall section having a radius (R) of curvature and a centre of curvature Cc on a line (T) tangential to an imaginary circle (I) centred at Cr, the wall section being symmetrical about the line (T);
defines a first elongate slit in the first sidewall extending from the top wall towards the bottom wall and communicating with the first bore, and a second elongate slit in the second sidewall extending from the top wall towards the bottom wall and
communicating with the second bore;
the wedge connector comprises
first and second prongs diverging away from one another at an angle α towards free ends thereof;
at least one web formation extending between the first and second prongs; and
mutually facing contact faces on the prongs configured to engage the radiused wall section of the bores;
the assembly being configured such that the first prong extends into the second bore of the first segment; the second prong extends into the first bore of the second segment; the at least one web formation extends through the second slit of the first segment and the first slit of the second segment; and
the mutually facing contact faces of the first and second prongs abut against the radiused wall sections, thereby mechanically securing the first and second pressure ring segments in side by side configuration.

2. The pressure ring assembly of claim 1 wherein the mutually facing contact faces on the prongs are shaped complementary to the radiused wall section of the bores.

3. The pressure ring assembly as claimed in claim 1 wherein the radius R of curvature is at least 15 mm, preferably at least 40 mm, and more preferably at least 70 mm.

4. The pressure ring assembly as claimed in claim 1 wherein the angle α is less than 15 degrees.

5. The pressure ring assembly as claimed in claim 1 wherein the centre of curvature (Cc) of the radiused wall section is located on the side of the radiused wall section opposite said adjacent sidewall.

6. The pressure ring assembly as claimed in claim 1 wherein the body of each segment comprises an inner face and an outer face which are separated by a thickness dimension d.

7. The pressure ring assembly as claimed in claim 6 wherein the radius R of curvature is larger than 50% of the thickness dimension d.

8. A pressure ring segment comprising a body extending arcuately between opposed first and second sidewalls thereof, the first and second sidewalls extending between a top wall and a bottom wall, the pressure ring segment defining first and second elongate bores adjacent the first and second sidewalls, respectively, each bore slanting away from the adjacent sidewall in a direction towards the bottom wall and having a radiused wall section facing the adjacent sidewall, the wall section having a radius (R) of curvature and a centre of curvature Cc, and defining a first elongate slit in the first sidewall extending from the top wall towards the bottom wall and communicating with the first bore, and a second elongate slit in the second sidewall extending from the top wall towards the bottom wall and communicating with the second bore.

9. The pressure ring segment of claim 8 wherein a centre of curvature Cc of the radiused wall section is located on the side of the radiused wall section opposite said adjacent sidewall.

10. The pressure ring segment as claimed in claim 8 wherein the body is made of at least one of copper, a copper alloy comprising at least 98% copper, a copper and silver alloy, aluminium bronze and stainless steel.

11. An inter-pressure ring segment wedge connector comprising a head; first and second prongs extending away from the head in diverging relationship relative to one another at an angle α towards free ends thereof; at least one web formation extending between the first and second prongs; and mutually facing curved contact faces on the prongs, the contact faces being radiused having a radius R of curvature and a centre of curvature Ccf.

12. The wedge connector as claimed in claim 11 wherein the centre of curvature Ccf of the curved contact face of the first prong is on the side of said curved contact face opposite the second prong.

13. The wedge connector as claimed in claim 11 wherein the at least one web formation extends laterally centrally between the first and second prongs, so that each prong provides first and second elongate contact face parts symmetrical relative to the at least one web formation.

14. The wedge connector as claimed in claim 11 wherein the head, the first and second prongs and the at least one web formation are integrally formed.

15. The wedge connector as claimed in claim 11 which is made of a non-magnetic steel material.
